(19) United States
(12) Patent Application Publication
(10) Pub. No.: US 2014/0028434 A1
(43) Pub. Date: Jan. 30, 2014

(54) SELF-RECOVERY CIRCUIT BREAKER

(71) Applicant: Chucheng Chang, Hsinchu City (TW)

(72) Inventor: Chucheng Chang, Hsinchu City (TW)

(73) Assignee: POLESTAR ELECTRIC INDUSTRIES CO., LTD., Jiangmen City (CN)

(21) Appl. No.: 13/558,322

(22) Filed: Jul. 25, 2012

(51) Int. Cl. H01H 61/04

(52) U.S. Cl. 337/14

(57) ABSTRACT

A self-recovery circuit breaker has a base, a holder, a self-recovery device and a cover. The base has two conductive pads and a top space with a top opening. The holder is mounted in the top space of the base. The self-recovery device is mounted in the holder and has two pins electrically and respectively connected to the conductive pads. The cover is mounted in the top opening of the base. The self-recovery device interrupts an electric connection between the conductive pads due to abnormally high current and high temperature. When the self-recovery device cools down, the self-recovery device will restore the electric connection between the conductive pads automatically.

### BACKGROUND OF THE INVENTION

1. Field of the Invention

The present invention relates to a circuit breaker, and more particularly to a self-recovery circuit breaker.

2. Description of Related Art

Fuse is a conventional overload protection device and is adapted to connect between a power supply and a load. The power supply, the fuse and the load form a current loop. The load can be multiple light bulbs. The power supply provides a working voltage and a current to activate the light bulbs.

The fuse allows the current that is lower than an upper limit to pass by. The upper limit of the fuse means a maximum current amplitude that the load is able to sustain. In unusual conditions, such as current overloading, the current may rise above the upper limit. When the current is above the upper limit, the fuse will be burned to interrupt the current loop. Hence, the load stops receiving the working voltage and the current from the power supply.

However, each time the fuse is burned, a user has to manually replace a burned fuse with a new one. It is inconvenient for the user.

### SUMMARY OF THE INVENTION

An objective of the present invention is to provide a self-recovery circuit breaker. The self-recovery circuit breaker can reconstruct the current loop automatically.

To achieve the foregoing objective, the self-recovery circuit breaker in accordance with the present invention comprises a body, a holder, a self-recovery device and a cover.

The base has two conductive pads and a top space with a top opening

The holder is mounted in the top space of the base.

The self-recovery device is mounted in the holder, has two pins electrically and respectively contacting the two conductive pads and forms an electric connection between the conductive pads when the temperature of the self-recovery device is lower than a threshold value.

The cover is mounted in the top opening of the base.

When the temperature of the self-recovery device is higher than the threshold value, the self-recovery device interrupts the connection between the conductive pads. When the temperature of the self-recovery device decreases to be lower than the threshold value, the self-recovery device restores the electric connection between the two conductive pads.

When the self-recovery circuit breaker in accordance with the present invention is connected between a load and a power supply, the power supply will provide a working voltage and current to the load through the self-recovery circuit breaker.

If the current flowing through the self-recovery device is above an upper limit, the temperature of the self-recovery device will rise above a threshold value. Then the impedance of the self-recovery device will turn very high, as in an open circuit condition, to break the electric connection between the conductive pads. No current passes the self-recovery device and the load. Hence, the load is protected from operating at abnormally high current.

Because no current passes the self-recovery device, the self-recovery device gradually cools down. The self-recovery device maintains an open circuit condition until the temperature decreases to be lower than the threshold value. When the temperature of the self-recovery device is lower than the threshold value, the self-recovery device automatically restores the electric connection between the conductive pads. Therefore, the load can receive the working voltage and the current to be activated again. The user needs not manually replace the self-recovery circuit breaker.

### BRIEF DESCRIPTION OF THE DRAWINGS

FIG. 1 is an exploded view of an embodiment in accordance with the present invention;

FIG. 2 is a cross-sectional view of the embodiment in accordance with the present invention;

FIG. 3 is a perspective view of the embodiment in accordance with the present invention; and

FIG. 4 is an operational view of the embodiment in accordance with the present invention.

### DETAILED DESCRIPTION OF THE PREFERRED EMBODIMENT

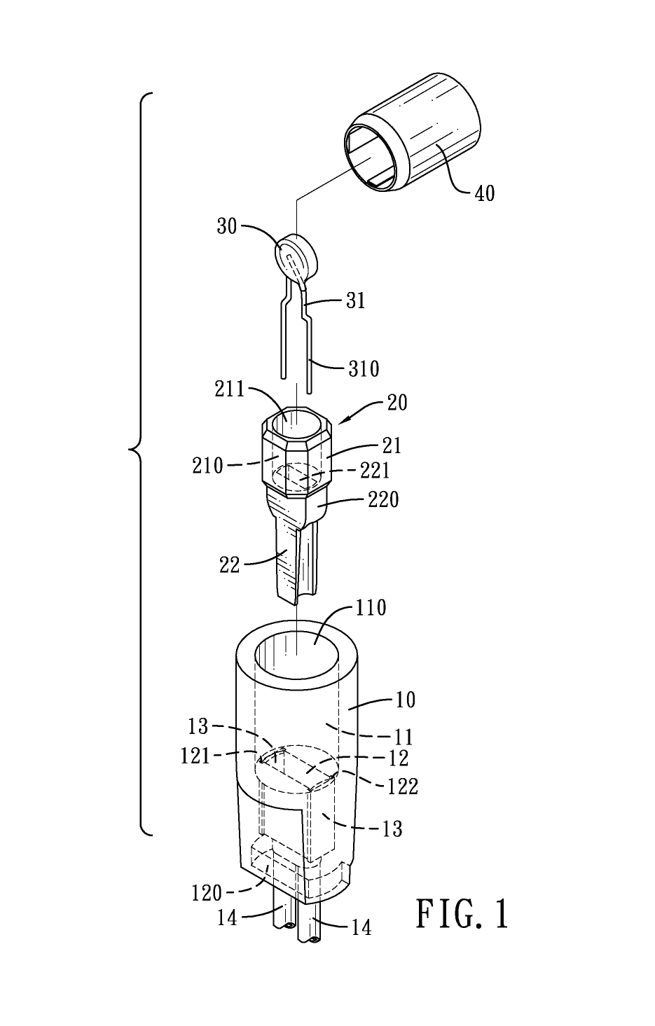

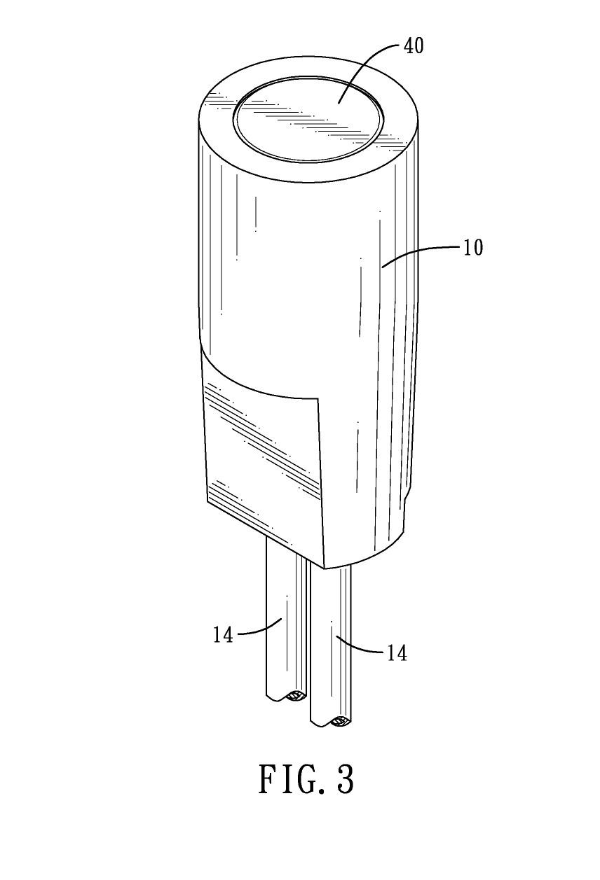

With reference to FIGS. 1-3, a self-recovery circuit breaker in accordance with the present invention comprises a base 10, a holder 20, a self-recovery device 30 and a cover 40.

The base 10 has a top, a bottom, a top space 11, a bottom space 12 and two conductive pads 13. The top space 11 has a top opening 110 formed in the top of the base 10. The bottom space 12 communicates with the top space 11 and has a bottom opening 120 formed in the bottom of the base 10. In this embodiment, the bottom space 12 has a first groove 121 and a second groove 122 opposite the first groove 121. The two conductive pads 13 are respectively mounted in the first and the second grooves 121,122 and adapted to electrically connect to two wires 14. The wires 14 are respectively adapted to connect between a load and a power supply.

The holder 20 is mounted in the base 10 and has a body 21 and a tail 22 formed under the body 21. When the holder 20 is mounted in the base 10, the body 21 is situated in the top space 11 and the tail 22 is situated in the bottom space 12. The body 21 has a space 210 with a top opening 211. The tail 22 has an outer surface 220 and a through hole 221 communicating with the space 210 of the body 21.

The self-recovery device 30 is mounted in the space 210 of the holder 20 and has two pins 31 respectively contacting the conductive pads 13 in the base 10 to form an electric connection between the two conductive pads 13. In this embodiment, the pin 31 has a distal terminal 310 extending through the space 210 of the body 21 and the through hole 221 of the tail 22 and being bent upward to lean between the outer surface 220 of the tail 22 and the conductive pad 13. The self-recovery device 30 can be a positive temperature coefficient (PTC) thermistor or a voltage dependent resistor (VDR).

The cover 40 is mounted in the top space 11 of the base 10.

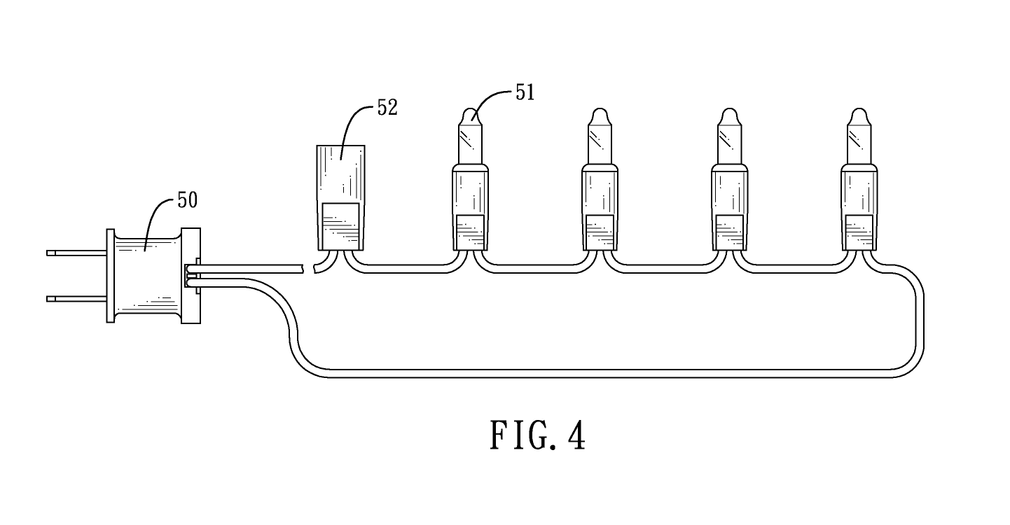

With reference to FIG. 4, an operational view of the self-recovery circuit breaker is illustrated. The self-recovery circuit breaker 52 in accordance with the present invention is electrically connected between a plug 50 and multiple light bulbs 51. The plug 50 is adapted to connect to a power supply. The light bulbs 51 are regarded as a load.

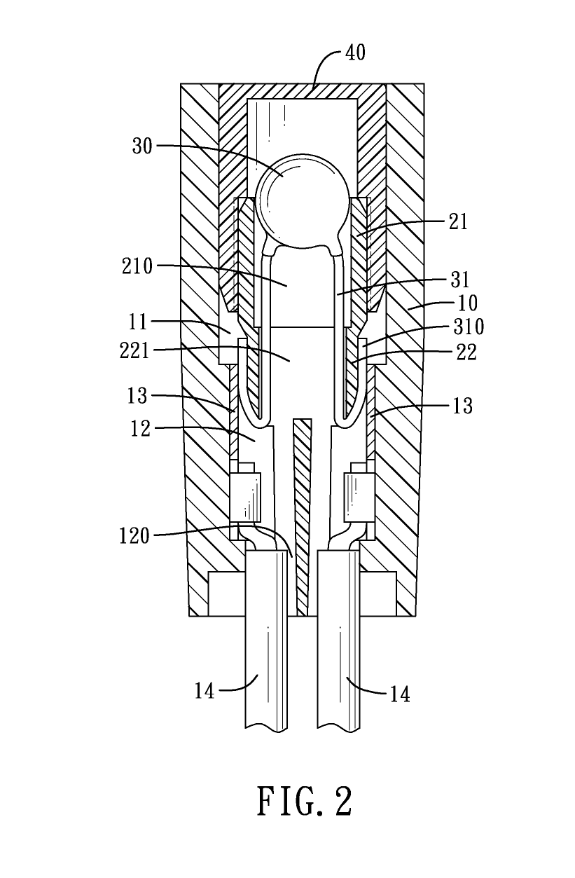

The power supply provides a current flowing through the light bulbs 51 through the self-recovery circuit breaker 52. With reference to FIG. 2, as the current flows through the self-recovery device 30, the temperature of the self-recovery device 30 rises. The temperature of the self-recovery device 30 is positive proportional to the amplitude of the current.

If an unusual condition occurs, such as current overloading, the current will rise rapidly, so that the temperature of the self-recovery device 30 rises. If the current is above an upper limit, the temperature of the self-recovery device 30 will rise above a threshold value, wherein the upper limit means a maximum current amplitude that the load is able to sustain. When the temperature of the self-recovery device 30 rises above the threshold value, the impedance of the self-recovery device 30 turns to high impedance. Such a high impedance can be regarded as an open-circuit condition that interrupts the electric connection between the two conductive pads 13. Hence, the current from the power supply cannot flow through the light bulbs 51. The light bulbs string is protected from operating in a high current condition.

Because the current does not flow through the self-recovery device 30, the self-recovery device 30 gradually cools down. When the temperature of the self-recovery device 30 is lower than the threshold value, the impedance of the self-recovery device 30 decreases and then the self-recovery device 30 automatically restores the electric connection between the two conductive pads 13 again. Therefore, the current provided from the power supply can flow through the self-recovery circuit breaker 52 and the light bulbs 51 to activate the light bulbs 51.

What is claimed is:

1. A self-recovery circuit breaker for light bulb string comprising:
a base having:
two conductive pads; and
a top space with a top opening;
a holder mounted in the top space of the base;
a self-recovery device mounted in the holder, having two pins electrically and respectively contacting the two conductive pads, and forming an electric connection between the conductive pads when the temperature of the self-recovery device is lower than a threshold value; and
a cover mounted in the top opening of the base; wherein:
when the temperature of the self-recovery device is higher than the threshold value, the self-recovery device interrupts the electric connection between the conductive pads; when the temperature of the self-recovery device decreases to be lower than the threshold value, the self-recovery device restores the electric connection between the two conductive pads.

2. The self-recovery circuit breaker as claimed in claim 1, wherein:
the base has a bottom space communicating with the top space;
the holder has:
a body having a space and situated in the top space of the base; and
a tail formed under the body, situated in the bottom space of the base and having a through hole communicating with the space of the body.

3. The self-recovery circuit breaker as claimed in claim 2, wherein:
the self-recovery device is mounted in the space of the body;
the two pins of the self-recovery device respectively extend through the space of the body and the through hole of the tail and respectively contact the conductive pads.

4. The self-recovery circuit breaker as claimed in claim 2, wherein:
the bottom space of the base has a first groove and a second groove opposite each other;
the conductive pads are respectively mounted in the first and second grooves.

5. The self-recovery circuit breaker as claimed in claim 3, wherein:
the bottom space of the base has a first groove and a second groove opposite each other;
the conductive pads are respectively mounted in the first and second grooves.

6. The self-recovery circuit breaker as claimed in claim 4, wherein the self-recovery device is a positive temperature coefficient (PTC) thermistor.

7. The self-recovery circuit breaker as claimed in claim 5, wherein the self-recovery device is a positive temperature coefficient (PTC) thermistor.

8. The self-recovery circuit breaker as claimed in claim 4, wherein the self-recovery device is a voltage dependent resistor (VDR).

9. The self-recovery circuit breaker as claimed in claim 5, wherein the self-recovery device is a voltage dependent resistor (VDR).
